(19) United States
(12) Patent Application Publication
(10) Pub. No.: US 2024/0042853 A1
(43) Pub. Date: Feb. 8, 2024

(54) MOUNT FOR VEHICULAR HEADS-UP DISPLAY

(71) Applicants: Ralf ROTTMANN, Drolshagen (DE); Philipp Menn, Hilchenbach (DE)

(72) Inventors: Ralf ROTTMANN, Drolshagen (DE); Philipp Menn, Hilchenbach (DE)

(21) Appl. No.: 18/214,563

(22) Filed: Jun. 27, 2023

(30) Foreign Application Priority Data
Aug. 3, 2022 (DE) 102022119496.5

(51) Int. Cl. B60K 35/00; G02B 27/01

(52) U.S. Cl. CPC B60K 35/00; G02B 27/0149; B60K 2370/816

(57) ABSTRACT

A mount carries a heads-up display in an electric vehicle having two A-pillars and a cross beam extending transversely between the pillars, a support fixed to the cross beam and traversed by a steering column of the vehicle, and two transversely spaced flat brackets extending parallel to each other longitudinally forward from the support and embracing the display. Each bracket is formed wholly of sheet steel and has having a straight upper edge projecting longitudinally forward and downward and formed with a bent-out edge strip and an angled lower edge converging longitudinally away from the cross beam toward the upper edge and having a bent-out edge strip. Each bracket further has a front end provided with an attachment plate constructed for attachment to a vehicle firewall and a rear end formed with an upper hole constructed to receive a fastener securing the respective bracket to the support.

### FIELD OF THE INVENTION

The present invention relates to a vehicular heads-up display. More particularly this invention concerns a mount for such a display.

### BACKGROUND OF THE INVENTION

A motor vehicle, in particular electric, typically has a body with at least two A-pillars, a cross beam connected to the A-pillars, a windshield connected to the vehicle body, a support attached to or connected to the cross beam, and two brackets for the heads-up display attached to the support and to the cross beam and spaced from and parallel to one another. The brackets each have an end directed toward and connected to a firewall of the body and have fittings for connecting (fastening) the heads-up display. A steering column of the electric vehicle passes through the cross beam in the region of the brackets fastened thereto. The term “heads-up display” typically refers both to the projector that emits the display and to what is displayed by this projector on the vehicle's windshield, normally forward of the steering wheel.

So-called augmented reality heads-up, displays are well known in themselves. They are information instruments that display real measurement data with additional texts, images or three-dimensional animations. In this way, useful information and warnings can be projected directly into the field of vision on the windshield within the limits of the system. These displays, known as HUD's for short, have a size of DIN A4 sheets, for example, so that considerably more information can be projected into the field of vision of the windshield. In electric vehicles, these HUD's are mounted on the cross beam in such a way that the projected display is on the windshield of the vehicle equipped with them and is visible to the driver. The installation volume of these HUD's is relatively large, so that a corresponding installation space must be available below the windshield on the cross beam, and the steering column must be accommodated near the installed HUD. The space required is available in electric vehicles because the engine compartment otherwise used in gasoline or diesel vehicles is not occupied by any power units in vehicles with a front engine.

Such HUD's have proven themselves. However, there is a need to improve them. Up to now, such HUD's have been mounted with the aid of supports that are extend between the cross beam and the HUD. For weight reasons, these supports are often manufactured from die-cast metal, especially magnesium. These materials are extremely expensive, and entail an undesirable consumption of rare or expensive raw materials. In addition, special measures must be taken with such materials to ensure or increase dynamic stiffness in conjunction with HUD displays, as this is necessary for the function and mode of operation of the HUD. In particular, this is also the case if such HUD's are also to be used for autonomous driving in the future. In corresponding tests, certain targets for the natural frequencies of the HUD and defined limit levels must be adhered to.

Also, it is known to manufacture such supports for HUD's from high-quality plastic that can withstand permanent loads, at about 80° C., and have permanent stability. Such plastic is relatively expensive and critical in application.

### Objects of the Invention

It is therefore an object of the present invention to provide an improved mount for a vehicular heads-up display.

Another object is the provision of such an improved mount for a vehicular heads-up display that overcomes the above-given disadvantages, in particular that is easy to install, of relatively low weight and high dynamic stiffness.

Another object is the provision of such a mount that conserves materials and that has a permanent and considerable load capacity. Since the corresponding installations are to be made between the passenger compartment of the vehicle and the firewall of the vehicle, it must also be taken into account that in the event of a front-end impact and in the event of a subsequent damage to the firewall, sufficient energy absorption can take place and is ensured.

### SUMMARY OF THE INVENTION

The invention is a mount used in combination with an electric vehicle having two A-pillars and a cross beam extending transversely between the pillars, a support fixed to the cross beam and traversed by a steering column of the vehicle, and two transversely spaced flat brackets extending parallel to each other longitudinally forward from the support. Each bracket is formed wholly of sheet steel and has a straight upper edge projecting longitudinally forward and downward and formed with a bent-out edge strip and an angled lower edge converging longitudinally away from the cross beam toward the upper edge and having a bent-out edge strip. Each bracket further has a front end provided with an attachment plate constructed for attachment to a vehicle firewall and a rear end formed with an upper hole constructed to receive a fastener securing the respective bracket to the support. A plurality of attachment fittings is provided on the upper edges, and a heads-up-display embraced between confronting flat faces of the two brackets and having transversely projecting attachment tabs above the attachment fittings on the upper edges and constructed to be fastened to the attachment fittings on the upper edges to secure the display below a windshield of the vehicle.

The fact that the bracket is made of sheet steel provides an environmentally friendly and highly resilient design solution. Steel has a much higher modulus of elasticity than, for example, magnesium or plastic, so that the resultant rigid design solution meets the requirements for dynamic rigidity. In particular, this reduces natural frequencies during intended use that can act on the heads-up display. The folded edges also provide stiffening of the bracket. The specified shape also ensures a material-saving design of the bracket. The connection of the attachment fittings with the bracket to the support fastened to the cross beam is made possible in a simple manner by fasteners, for example screws, with plate-like connecting lugs being provided at the ends of the brackets to form the connection point to the firewall. The heads-up display fastened to the brackets has, for example, laterally projecting fastening tabs that can be placed on the attachment fittings of the upper edges or their folded edges and fastened thereto, for example by screws, so that secure fastening of the heads-up display is ensured.

The chosen shape and design as well as the fastening of the brackets also ensure that energy absorption can take place to a sufficient extent in the event of a frontal crash of the vehicle equipped with them and crushing of the firewall or firewall.

The heads-up display projects images through slots or openings in the dashboard or the like above the heads-up display, so that the images generated by the heads-up display are projected onto the windshield.

The sheet steel forming the brackets is preferably made of low-alloy structural steel, with other components of the respective bracket being fastened by means of welding processes.

Preferably, the bracket closer to the outside of the electric vehicle, i.e. the door, has only one attachment fitting for the heads-up display.

It is also preferred that the bracket farther away from the outside of the electric vehicle and closer to the center of the vehicle has two attachment fittings for the heads-up display spaced apart from one another in the longitudinal vehicle-travel direction. This ensures three-point support of the heads-up display on the brackets for easy installation and safe mounting and imparts sufficient rigidity to the brackets.

Preferably, each bracket has, near the first end between the bent-out edges, the first holes for fasteners for connection to the support of the cross beam. This serves to securely position and fasten the bracket to the respective support.

For the same reason, each bracket has, near the angled lower edge, and in fact also near the angle, second holes for fasteners for connection to the support of the cross beam. This ensures a high level of positional security after the brackets have been mounted and also a high level of rigidity of the mount assembly. Preferably, the attachment fittings for the heads-up display are made of plastic, preferably PP or PA reinforced with glass and/or carbon fibers, with the fiber content preferably being 30%±5%.

This design ensures that vibrations acting on the brackets during operation of the vehicle and use of the display are damped, so that transmission of vibrations from the brackets to the heads-up display is largely prevented.

A preferred design in terms of production technology and ensuring long-term load-bearing capacity is that the attachment fittings are made of injection-moldable material and each have a block body with a threaded insert opening at the upper edge of the bracket and connected by casting to a counter-bearing at the bend between the two straight sections of the lower edge via a reinforcement crosspiece on the bracket.

The attachment fittings are securely fixed in that, on the one hand, they are formed with the block body on the upper edge of the bracket and, on the other hand, they are connected via the cross beam to an abutment on the bend of the lower edge, so that permanent positional stability is ensured.

It is also preferred that the plate-shaped brackets are adjustable in the X and Z directions. This adjustability allows exact positioning of the HUD support surfaces.

In addition, it is preferred that the threaded inserts are internally threaded bushings made of stainless steel recessed in the attachment fittings for fastening the heads-up display. This ensures the permanent attachment of the heads-up display to the attachment fittings.

Furthermore, at least one plate-like connecting lug has a seat or receptacle, in particular a centering bushing, as a tolerance-compensating element for a bolt, which is fastened to the firewall or end wall of the vehicle. Such a reference bolt provides assistance in mounting in the correct position. This makes it easy to set the fastening points on the firewall or end wall correctly and to align the brackets exactly.

Furthermore, it is preferred that the steel parts are provided with an anticorrosion coating, preferably an electroplated zinc coating.

Another object of the invention is a mount for securing an augmented reality heads-up display in an electric vehicle, comprising a cross beam, a support fastened to the cross beam or connected thereto, two brackets for the heads-up display fastened to the support and to the cross beam, spaced apart from one another and aligned parallel to one another, each of which brackets has an outer end directed toward a front firewall of a vehicle body, which is connected to the firewall, the brackets extending in an X direction, namely in the longitudinal direction of the vehicle, and having interfaces for connecting (fastening) the heads-up display, it being possible for a steering column of the electric vehicle to reach through the support in the region of the brackets fastened thereto, which is characterized in that each bracket comprises a shaped part made of steel which is formed from a steel sheet metal with a straight upper edge directed toward the front vehicle end in the longitudinal direction of the vehicle and an angled lower edge likewise directed there, the brackets having bent-out edges directed away from one another on both longitudinal regions of the edges, the first ends fastened to the support converging in the manner of a U-shaped profiling and having first perforations for fasteners for fastening to the support and ending convergently at the second ends facing away from the cross beam and each having a plate-like connecting tab on the end face, the connecting tabs forming the interface (connecting point) with the firewall, attachment fittings for supporting and fastening the heads-up display being formed in the region of the upper edges or their bent edges. The connecting tabs can be welded to the second ends.

### BRIEF DESCRIPTION OF THE DRAWING

The above and other objects, features, and advantages will become more readily apparent from the following description, reference being made to the accompanying drawing in which:

FIG. 1 is a perspective view of the display and mount of this invention;

FIG. 2 is a partly exploded view of the structure of FIG. 1;

FIGS. 3A and 3B are perspective views of the two mounting brackets of the invention;

FIG. 4 is a detail view of a centering element of the invention;

FIG. 5 is a detail view of the heads-up display; and

FIG. 6 is a perspective view of the mounting frame of this invention.

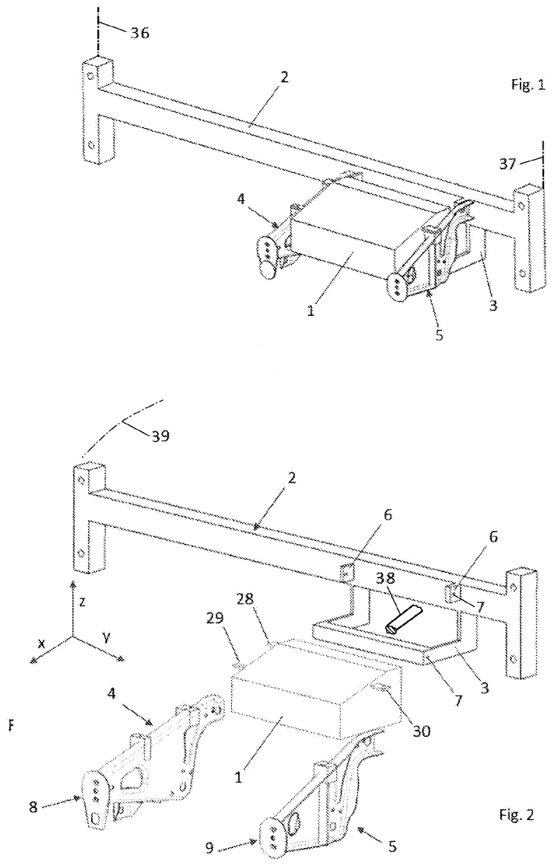

### SPECIFIC DESCRIPTION OF THE INVENTION

As seen in the drawing, a mount for an augmented-reality heads-up display 1 in use is carried on the vehicle body by a cross beam 2 extending between the vehicle's two A-pillars 36 and 37. The vehicle's windshield is shown schematically at 39 and steering column at 38. A support 3 is attached to or connected to the cross beam 2. This cross beam 2 and the support 3 have fastening options for brackets 4 and 5 of the heads-up display 1 described below. For this purpose, two lugs 6 formed with respective mounting holes 7 are provided on the cross beam 2. Further such holes 7 are also provided on the support 3. The two brackets 4 and 5 for the heads-up display 1 are spaced apart and extend parallel to one another and are bolted, riveted, or otherwise fastened at the holes 7 to the support 3 and to the cross beam 2. The brackets 4 and 5 have respective front ends 8 and 9 directed toward and connected to an unillustrated firewall.

The brackets 4 and 5 extend essentially in the direction of the longitudinal axis or normal travel direction of the vehicle shown at x in the drawing. The brackets 4 and 5 are constructed for attachment to the heads-up display 1. In addition, an unillustrated steering column of the electric vehicle extends through the support 3 in the mounting position in the region of the brackets 4 and 5 attached thereto.

Each of the brackets 4 and 5 consists of shaped steel sheet metal with a respective straight upper edge 10 and 11 directed toward the front end of the vehicle in the longitudinal direction x of the vehicle. Each of the approximately triangular brackets 4 and 5 also has a respective lower edge 12 and 13 forming a right angle. The brackets 4 and 5 each have respective upper edges 14, 15 and lower edges 16, 17 bent outward away from one another and from the plane of the respective bracket 4 or 5, so that the confronting faces of the brackets 4 and 5 are flat and only the angled bent-out edges 14, 15, 16, 17 project outward, forming a substantially flat contact surface between the brackets 4 and 5 for the heads-up display 1.

Rear ends 19 and 20 of the brackets 4 and 5 are fastened to the support 3, form with their edges 10, 11 or 12, 13 mutually converging regions that are brought together in the manner of a U-shaped profiling at their rear ends 19, 20 and have first perforations 21, 22 in the regions lying between the bent-out edges 14, 16 or 15, 17 for fastening to the support 3. The perforations 21, 22 are aligned approximately coaxially with the holes 7 of the lugs 6, so that fasteners can be guided and attached therethrough. The ends of the brackets 4 and 5 remote from the cross beam 2 have respective converging edges 10, 12 and 11, 13 and are each provided at the end face with plate-like connecting tabs or lugs 23, 24. These connecting lugs 23, 24 form the connection points to the unillustrated firewall. In the region of the upper edges 10, 12 or corresponding folded edges 14, 15, there are fittings 25, 26, 27 for supporting and fastening the heads-up display 1, for which purpose the heads-up display 1 has tab-shaped fastening projections 28, 29, 30. Corresponding holes for fasteners are provided in these mutually complementary parts.

The bracket 4, which is further in the transverse direction, i.e. in the Y-direction, from the outside of the electric vehicle, has for the heads-up display 1 the two fittings 25, 26 that are spaced apart from one another in the longitudinal direction.

The bracket 5 closer to the outside of the electric vehicle has only one such fitting 27 for the heads-up display 1. While each bracket 4 and 5 has the first holes 21, 22 between the bent-out edges 16, 19 or 17, 20 for fasteners for connection to the support 3 or the cross beam 2 at the lugs 6, each bracket 4 and 5 has second holes 31, 32 near the angled lower edge 12, 13 and specifically in the area of the bend for fasteners for connection to the lower holes 7 of the support 3 of the cross beam 2.

The fittings 25, 26, 27 for the heads-up display 1 are made of plastic, preferably PP or PA. Preferably, this plastic is reinforced with glass fibers and/or carbon fibers. In this case, the fiber filling proportion can preferably be in the range of 30%+5%.

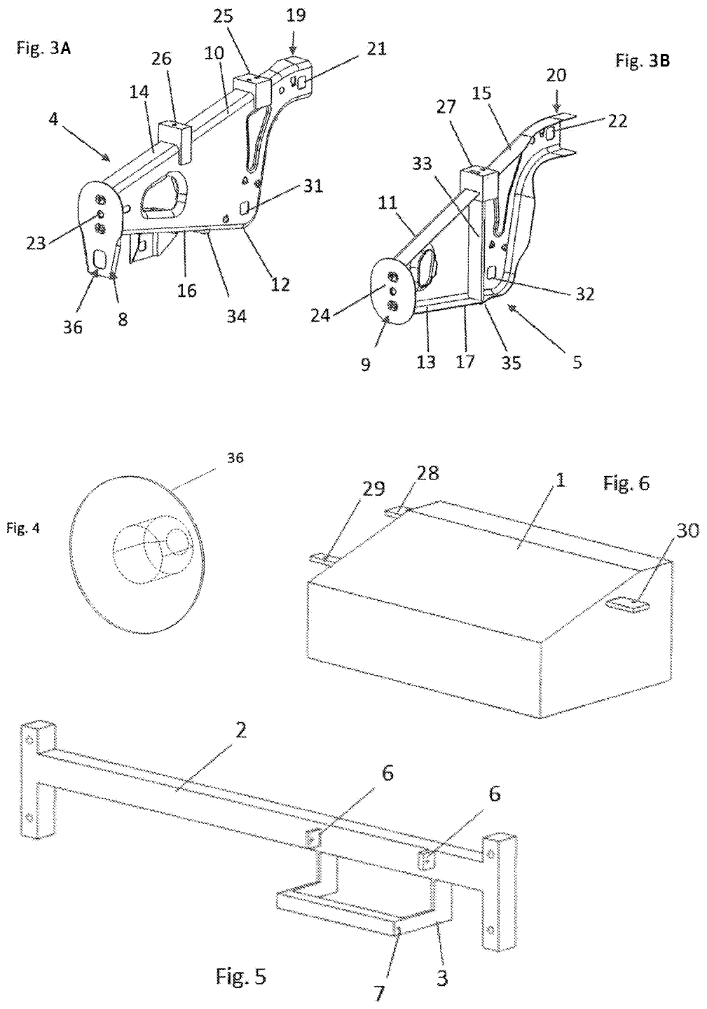

In addition, the fittings 25, 26, 27 are injection molded and each have a block-like body 14, 15 at the upper edge 10, 11 of the respective bracket 4 and 5, a casting connection being produced via a crosspiece brace or leg 33 of the bracket 4 and 5 fitting in a seat 34, 35 on the bent edge 16 or 17 of the lower edge 12 or 13. The brace 33 is only shown on the right in FIG. 3. In FIG. 3 on the left, it is located on the far side of the bracket 4. The seat grooves 34 and 35 are formed along the lower edge in the underside of the bent edge 16 or 17 or are provided there.

Stainless steel threaded bushings are preferably held in the fittings 25, 26, 27 for securing the heads-up display 1 to it.

The flat connecting tabs 23, 24 have tolerance-compensating elements so that they can be aligned and fixed relative to the attachment point. The connecting tab 23 in particular has a centering bushing 36, preferably made of plastic, as an interface or receptacle for a reference pin, which is inserted into the corresponding receptacle 36′.

All steel parts of the specified solution are provided with an anticorrosion coating, preferably with an electroplated zinc coating. In particular, the brackets 4 and 5 have a sheet thickness of preferably 0.8 mm to 2.0 mm.

Some essential components are shown only schematically and not in the form in which they are used in reality. This applies in particular to the heads-up display 1, the cross beam 2 and the support 3.

The design according to the invention achieves in particular a high dynamic stiffness of the connection geometry for the HUD projector so that it can project a vibration-free image onto the projection surface, namely the windshield 39 of the vehicle.

The invention is not limited to the embodiment shown, but is variable in many ways within the scope of the disclosure.

All new individual and combination features disclosed in the description and/or drawing are considered essential to the invention.

We claim:

1. In combination with an electric vehicle having two A-pillars and a cross beam extending transversely between the pillars:
a support fixed to the cross beam and traversed by a steering column of the vehicle;
two transversely spaced flat brackets extending parallel to each other longitudinally forward from the support, each formed wholly of sheet steel, the brackets each having a straight upper edge projecting longitudinally forward and downward and formed with a bent-out edge strip and an angled lower edge converging longitudinally away from the cross beam toward the upper edge and having a bent-out edge strip, each bracket having a front end provided with an attachment plate constructed for attachment to a vehicle firewall and a rear end formed with an upper hole constructed to receive a fastener securing the respective bracket to the support;
a plurality of attachment fittings on the upper edges; and
a heads-up-display between the two brackets and having transversely projecting attachment tabs above the attachment fittings on the upper edges and constructed to be fastened to the attachment fittings on the upper edges to secure the display below a windshield of the vehicle.

2. The combination according to claim 1, wherein one of the brackets carries only a single one of the attachment fittings.

3. The combination according to claim 2, wherein the other of the brackets carries only two of the attachment fittings spaced longitudinally apart.

4. The combination according to claim 1, wherein the upper holes of the rear ends of the brackets are between the respective bent-out edge strips.

5. The combination according to claim 1, wherein each bracket has a lower transversely throughgoing hole constructed to receive a fastener securing the respective bracket to the holder.

6. The combination according to claim 1 wherein the attachment fittings for the heads-up display (1) are made of plastic with a fiber filling proportion being 30%±5%.

7. The combination according to claim 1, wherein the attachment fittings are injection-molded and each have a block body with an internally threaded insert and riding on of the upper edge of the respective bracket, the block body being unitary with a vertical crosspiece on the respective bracket.

8. The combination according to claim 7, in the X and Z directions wherein the inserts are of stainless steel.

9. The combination according to claim 1, wherein the brackets 5) are adjustable vertically and horizontally.

10. The combination according to claim 1, wherein the bent-out edge strips of each bracket project away from the other bracket and the edge strips project substantially at a right angle from a planar sheet-steel panel with which they are unitary.

11. The combination according to claim 1, further comprising on each of the attachment plates:
a respective centering bushing as a tolerance compensation element for a reference bolt mounted to the firewall or end wall of the vehicle.
